(19) United States
(12) Patent Application Publication
(10) Pub. No.: US 2026/0219370 A1
(43) Pub. Date: Jul. 30, 2026

(54) LIGHT DEVICE FOR OBJECT DETECTION

(71) Applicant: VALEO VISION, BOBIGNY Cedex (FR)

(72) Inventors: Matheo GOURDON, Bobigny (FR); Mickael MIMOUN, Bobigny (FR); Sidahmed BEDDAR, Bobigny (FR); Geoffrey PIQUARD, Bobigny (FR); Hafid EL-IDRISSI, Bobigny (FR); Pierre RENAUD, Bobigny (FR)

(73) Assignee: VALEO VISION, Bobigny (FR)

(21) Appl. No.: 19/143,738

(22) PCT Filed: Dec. 22, 2023
(86) PCT No.: PCT/EP2023/087521

§ 371 Date: Jun. 26, 2025

(30) Foreign Application Priority Data
Dec. 29, 2022 (FR) 2214674

(51) Int. Cl. G01S 7/484; G01S 7/481; G01S 7/4865; G01S 17/10; G01S 17/931

(52) U.S. Cl. CPC G01S 7/484; G01S 7/4815; G01S 7/4865; G01S 17/10; G01S 17/931

(57) ABSTRACT

One aspect of the invention relates to a light device for a motor vehicle. The light device includes a plurality of light modules emitting pulsed visible light, which light is modulated by means of a high-frequency light code, each light module includes at least two sectors each grouping a plurality of light-emitting diodes around a driver circuit, and a device for receiving the light emitted by each of the light modules after it has reflected off an object, wherein the light module includes a delay-locked loop connected to the driver circuit of each of the sectors to ensure synchronization of the driver circuits. Another aspect of the invention relates to a driver assistance system of a motor vehicle, the system comprising at least one such light device.

### TECHNICAL FIELD

The present invention relates to a luminous device, for a motor vehicle, suitable for object detection. The invention also relates to a driving assistance system for a motor vehicle comprising this luminous device.

### BACKGROUND OF THE INVENTION

With the development of autonomous motor vehicles, driving assistance means have greatly improved in recent years. One of the most useful assistance means is the assistance means for detecting pedestrians or objects in the environment of the vehicle.

Devices for detecting the presence of pedestrians or objects in the environment of the vehicle, simply called object detection devices, are known. These devices generally use what is known as lidar (light detection and ranging) technology, which is based on analyzing properties of a light beam, generally a laser beam, emitted by a specific light source and reflected by the object. With lidar technology, the distance between the light source and the object is measured based on the time lag between the emission of a laser pulse and the reception of the reflected pulse. An object detection device using a lidar is relatively simple to implement because the light source emits a single high-power infrared signal that bounces back off the object; the time of flight of the infrared signal is measured when said signal is received by a sensor. However, such an object detection device requires specific equipment to emit the infrared signal and to receive the bounced-back signal.

In order to ensure a detection rate and/or false-positive rate in line with the standard, complementary technologies are required. For this purpose, three assistance devices based on different technologies are generally combined with one another; the data generated by these various assistance devices are cross-checked and final data are generated to inform the driver, or the vehicle itself in the case of an autonomous vehicle, of the presence of a pedestrian or object in the environment of the vehicle. However, the addition of three distinct devices in one and the same zone of the vehicle places load on a zone upon which high demands are already placed in terms of crowding.

To address crowding problems, it has been envisaged to carry out object detection using the lighting that is already present on the vehicle, such as the daytime running lights of the vehicle. However, the light source of modern luminous devices is generally a set of light-emitting diodes, controlled from a driver circuit. Now, light-emitting diodes (LEDs) in vehicle luminous devices emit visible light continuously, thereby making light difficult to detect after reflection from the object, in particular because it is combined with natural sunlight, light from street lamps and other outdoor light sources. To facilitate the detection of light emitted by the LEDs and reflected by the object, it has been envisaged to modulate the light; the light beam emitted by the LEDs is then pulsed and modulated by a high-frequency code. However, to be effective, and therefore detectable, the modulation of the light beam must be precise; the LEDs forming the light source must therefore all emit their light ray simultaneously so as not to generate interference. Now, the current trend is to deploy LEDs, in rows, in layers or in grids, to achieve style effects, which means that some of them are moved away from the driver circuit that controls them; the fact that the LEDs are closer to or further away from the driver circuit causes a time lag in the emission of the light ray from some LEDs compared to others. Said lag causes the emissions of signals to be spread over time, which has two consequences. First of all, this lag at emission is carried over to the signal that has been reflected from an object, and which is retransmitted to a sensor present on the vehicle. It is therefore more difficult to determine the time lag between the emission of a light pulse and the reception of the reflected pulse. Second of all, the spread of the pulses degrades the signal-to-noise ratio. Indeed, all other things being equal, the intensity of a simultaneous pulse is detected more easily at the sensor than the intensity of a plurality of emissions spread over time.

### SUMMARY OF THE INVENTION

In order to address the abovementioned problems of interference and time lag in emission by LEDs, the applicant proposes a luminous device suitable for object detection in which the LEDs are grouped together into sectors around a driver circuit that supplies them with electricity, the driver circuits being synchronized by way of a delay-locked loop.

According to a first aspect, the invention relates to a luminous device for a motor vehicle, comprising:
at least one first luminous module configured to emit pulsed visible light modulated so as to transmit a high-frequency luminous code, the at least one first luminous module comprising at least two sectors each grouping together multiple light-emitting diodes that are supplied with electric power by a driver circuit configured to modulate, in accordance with
the high-frequency code, an electric power received by the light-emitting diodes in order to emit the emitted pulsed visible light, and
a reception device for receiving the light emitted by the at least one first luminous module, for receiving the luminous code after reflection of the pulsed light emitted by the at least one luminous module from an object,
wherein the at least one first luminous module comprises a delay-locked loop connected to the driver circuit of each of the sectors of the respective luminous module in order to synchronize the modulation, in accordance with the code, carried out by said driver circuits.

A luminous device is a luminous element configured to be installed in the vehicle, and preferably comprises a housing configured to be installed in the vehicle, in which a luminous module is installed. Preferably, multiple luminous modules are installed in the housing.

A luminous module is preferably a set of components that are integral with one another. Preferably, a luminous module may be installed in the housing of a luminous device. Preferably, the luminous module is configured to perform or contribute to regulatory lighting or signaling functions. When the luminous module contributes to implementing a signaling or lighting function, it should be understood that at least one other luminous module, for example contained in another luminous device, helps to implement the function.

Light-emitting diodes (LEDs) are understood to mean light-emitting sources that emit incoherent light, as are known for being well suited to use for signaling or lighting luminous devices for motor vehicles, as opposed to laser sources (including laser diode sources). Indeed, laser sources emit temporally and spatially coherent light, and have the drawback of posing risks for eye safety, meaning they have to be controlled using complex and expensive means.

It should be understood that the driver circuits are connected to the LEDs of their sector so as to supply them with electric power, while at the same time modulating the power received by the LEDs at high frequency in accordance with the code, such that the light emitted by the LED is modulated in accordance with the code. Preferably, a driver circuit may operate as a high-frequency switch capable of alternately blocking or letting through an electric power intended to supply electric power to the LEDs of the sector of the driver circuit. As an alternative, the driver circuit is provided with passive or preferably active means capable of adapting the electric power to be supplied to the LEDs of the sector of the driver circuit on the basis of the code received, so as to guarantee correct transmission of the code in the form of pulsed light.

The luminous devices according to the invention fulfil or at least contribute to lighting and/or signaling functions known to those skilled in the art. The lighting functions comprise for example the high beam, front fog beam and low beam functions. The signaling functions comprise for example the position light (PL), direction change indicator and daytime running light (DRL) functions. Said daytime running light and position light are particularly advantageous for implementing the invention, since these functions may be implemented by the same light-emitting diodes; the same light-emitting diodes may thereby contribute to a night-time and daytime detection function, while at the same time performing a regulatory signaling function. This thus provides a luminous device capable of contributing to a detection function, making it possible to avoid costs associated with a luminous device dedicated to a detection function while at the same time performing a regulatory function.

Moreover, the luminous device according to the invention is particularly suitable for implementing a complex DRL/PL function in which multiple sectors each comprising a plurality of LEDs are used to mark a distinctive style of the vehicle. In such luminous devices, it is common to find numerous LEDs distributed within one and the same module, for example at least 12 LEDs, preferably 30 LEDs, for example in rows, in layers or in grids. In a device according to the invention, these LEDs are distributed between multiple sectors, each supplied with power by a driver circuit supplying power to the LEDs of the respective sector.

Indeed, a device suitable for implementing a DRL/PL function makes it possible to implement a detection function using a majority of the LEDs necessary for the signaling function. A majority is understood to mean more than 50% of the LEDs assigned to the function transmit the code, preferably more than 75%, preferably all of the LEDs transmit the code. This is particularly relevant when the LEDs are similar in terms of flux emission characteristics and activation current. Since the majority of the LEDs contribute to the signaling function illuminating objects located in front of the motor vehicle, the detection of the pulsed light from the LEDs is thereby not disturbed by the detection of non-pulsed light emitted by the same function. This improves a signal-to-noise ratio of the reception of the luminous code by the sensor.

As an alternative, if the luminous function is implemented by dissimilar LEDs, it is advantageous for LEDs representing more than 50% of the luminous flux attributed to the function to transmit the code, preferably more than 75% of this flux, preferably all of this flux.

Similarly, it is advantageous to implement lighting functions such as low beam and high beam with light-emitting diodes whose supply of electric power is modulated at high frequency to transmit the code. Multiple light-emitting diodes are usually used to produce the low beam and the high beam, sometimes within one and the same luminous module, for example a dual-function luminous module. It is then preferred to use at least one driver circuit capable of modulating, at high frequency, the supply of power to the LEDs of a sector grouping together first LEDs necessary for the low beam function, in accordance with the code, and a driver circuit capable of modulating, at high frequency, the supply of electric power to the second LEDs of a sector grouping together LEDs necessary for the high beam function, in accordance with the same code, in a manner synchronized with the supply of electric power to the sector of the first LEDs. In another example, the high beam function and/or the low beam function comprise individually activatable and deactivatable LEDs, for example in order to emit a partial high beam in which some lighting zones are activated or deactivated, or, as an alternative or in addition, a low beam in which some LEDs corresponding to a light cut-off are activated or deactivated so as to move a central zone of a cut-off zone horizontally in relation to the vehicle when the luminous device is installed on the vehicle, and thus to implement a directional low beam function, known as a DBL (dynamic bending light). Since the majority of the LEDs emit pulsed light modulated in accordance with the code, the detection of the pulsed light from the LEDs is thereby not disturbed by the detection of non-pulsed light emitted by the same function. This improves a signal-to-noise ratio of the reception of the luminous code by the sensor.

With sectorized LEDs and a delay-locked loop connected between the driver circuits of the various sectors, the luminous module of this luminous device is capable of synchronously emitting all of the light rays forming the light beam of the luminous device, without any risk of interference. The luminous device according to the invention is thus suitable for object detection.

In addition to the features that have just been mentioned in the preceding paragraph, the luminous device according to one aspect of the invention may have one or more of the following additional features, taken individually or in any technically feasible combination:
the delay-locked loop is connected to an internal clock of each of the driver circuits so as to adjust the clock of a driver circuit that is running ahead to the clock of a driver circuit that is lagging behind.
in each sector, the light-emitting diodes are connected to the driver circuit by conductor tracks, all of the conductor tracks of one and the same sector having one and the same track length, such that all of the light-emitting diodes of one and the same sector are controlled synchronously by the driver circuit.
in each sector, the length of the conductor tracks is equal to the distance between the driver circuit and the light-emitting diode furthest from said driver circuit, the conductor tracks of the light-emitting diodes least far away from the driver circuit forming delay lines.
the reception device comprises at least one light sensor and one blue-light optical filter.
the reception device is connected to a computing unit that determines a time of flight of waves of modulated pulsed light and measures a distance between the object and the luminous device.
for each sector of the at least one first luminous module, the light-emitting diodes of the sectors are grouped together on one and the same substrate, in particular an FR4 or IMS substrate.
for each luminous module, the light-emitting diodes of one and the same luminous module are grouped together on one and the same substrate, in particular an FR4 or IMS substrate,
the device comprises, in addition to the at least one first luminous module, at least one second luminous module connected to the delay-locked loop of the at least one first luminous module.

Adjusting the clock of a driver circuit that is running ahead to the clock of a driver circuit that is lagging behind is understood to mean that the clocks of both circuits are brought to one and the same clock value, so that the modulation of the code by the two driver circuits is simultaneous, to within a residual.

A second aspect of the invention relates to a driving assistance system for a motor vehicle, characterized in that it comprises at least one first and one second luminous device according to the first aspect, combined with one other for the purpose of detecting one and the same object.

A third aspect of the invention relates to a driving assistance system for a motor vehicle, characterized in that it comprises at least one first device for detecting an object in the environment of the motor vehicle, the luminous device according to the first aspect constituting a second object detection device that provides redundancy for the first object detection device.

### BRIEF DESCRIPTION OF THE DRAWINGS

Other advantages and features of the invention will become apparent on reading the following description, which is illustrated by the figures, in which:

FIG. 1 schematically shows one example of a vehicle equipped with luminous devices according to the invention;

FIG. 2 schematically shows one example of modulated light pulses emitted by a luminous device according to the invention;

FIG. 3 schematically shows one example of a control signal transmitted by a driver circuit connected to a delay-locked loop according to the invention; and

FIG. 4 schematically shows one example of a luminous module comprising driver circuits connected to a delay-lock loop according to the invention.

In the figures, identical elements have been identified using identical reference signs. For the sake of the readability of the figures, the elements in the figures have not been shown scale.

### DETAILED DESCRIPTION OF THE INVENTION

One exemplary embodiment of a luminous device according to the invention is described in detail below, with reference to the appended drawings. This example illustrates the features and advantages of the invention. However, it will be recalled that the invention is not limited to this example.

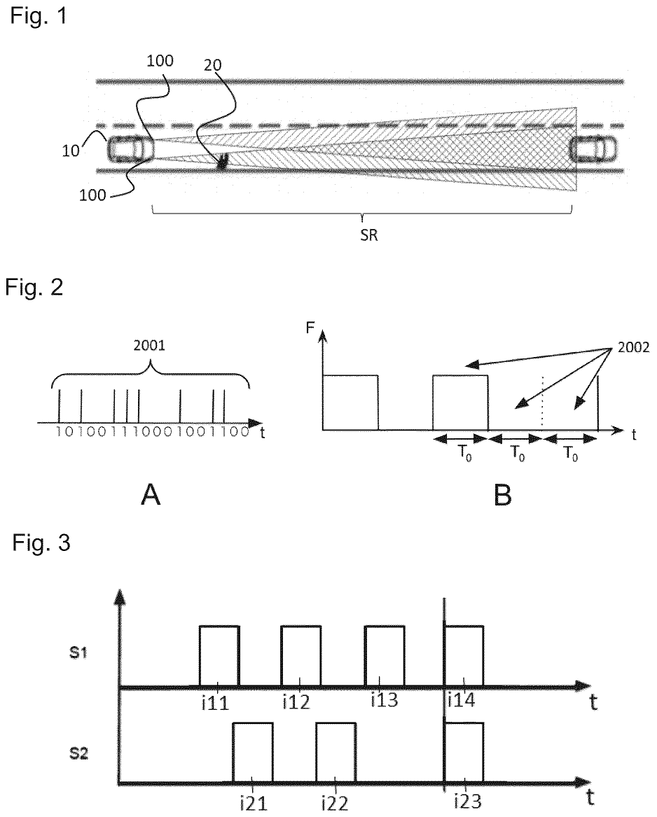

One example of a motor vehicle 10 equipped with two luminous devices 100 according to the invention is shown in FIG. 1. This example shows a pedestrian 20 crossing in front of the vehicle 10. The vehicle 10 is equipped with two luminous devices 100, for example daytime running lights, which illuminate the road scene SR ahead of the vehicle. The luminous devices 100 are integrated into a driving assistance system, using which the pedestrian 20 is able to be detected.

The luminous device 100 according to the invention may be any basic lighting device present on a vehicle. The luminous device 100 may for example be a daytime running light, a position light, a signaling light, a side light strip, a front light grid or any other external lighting means customarily integrated on a vehicle to allow it to be seen on the road; the luminous device is then used to detect pedestrians or objects on the road scene or in the external environment of the vehicle. The luminous device may also be a lighting device inside the vehicle; it may then be used to detect objects or people inside the vehicle.

The luminous device 100 is used to emit pulsed light modulated by a high-frequency luminous code. This luminous code is a binary cyclic code composed of a succession of 1 s and 0 s, the 1 s corresponding to a pulse, the Os corresponding to no emission of light. The light beam emitted by the LEDs contained in the luminous device is modulated so as to transmit the luminous code. The LEDs thus emit a succession of light pulses at a rate of around 10 to 20 ns, this corresponding to a high frequency of modulation of the supply of electric power to the LEDs from 10 MHz to 400 MHz, preferably 30 MHz to 200 MHz, preferably 50 to 100 MHz. One example of a code is shown in part A of FIG. 2, and one example of light pulses corresponding to this code is shown in part B of FIG. 2. It should be noted that, by emitting a light beam modulated by this code at high frequency, the human eye does not perceive this modulation. For the human eye, the light beam is continuous; the luminous code is invisible. The luminous code emitted via the modulation of the light beam may therefore be utilized for object detection.

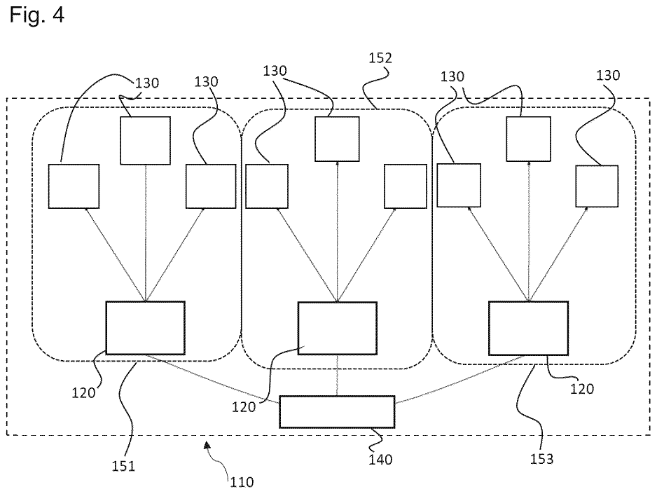

As shown schematically in FIG. 4, a luminous device 100 according to the invention comprises multiple luminous modules 110, which each comprise at least two driver circuits 120 and multiple white LEDs 130 organized into sectors 151, 152, 153. A driver circuit 120, also called a driver, is an item of equipment for supplying DC current to the LEDs to which it is connected. A driver circuit 120 therefore controls multiple LEDs 130. According to the invention, the luminous module 110 comprises multiple sectors 151, 152, 153, each comprising a driver circuit 120 to which multiple LEDs 130 are connected. In the example of FIG. 4, the luminous module 110 comprises three sectors 151, 152, 153, each comprising a driver circuit 120 and three LEDs 130. A sector 151, 152, 153 is a geographical zone of the luminous module in which a driver circuit 120 is connected to LEDs 130, all positioned in the environment of the driver circuit 120, at relatively short distances away from said driver circuit. The organization of the driver circuits and LEDs of the luminous module 110 into sectors makes it possible to position a driver circuit at a relatively small distance from each of the LEDs. Thus, no LED 130 of the luminous module is far from the driver circuit that controls it; all of the LEDs 130 of one and the same sector 151, 152, 153 are at more or less similar distances from the driver circuit 120 that controls them, thereby limiting or even avoiding the risk of a time lag when light rays are emitted by some of the LEDs.

In the example of FIG. 4, the luminous module 110 comprises three driver circuits and nine LEDs organized into three sectors. Of course, the number of sectors per luminous module, the number of driver circuits and the number of LEDs per sector are given only by way of example, and may vary in particular depending on the type of luminous device, the desired lighting effects, the arrangement of the LEDs, etc.

Regardless of the number of sectors 151, 152, 153 and/or of driver circuits 120, the luminous module according to the invention comprises a delay-locked loop (DLL) 140. A delay-locked loop 140 is a digital circuit for changing the phase of a clock signal. The DLL compensates for propagation delays, such that only a small lag remains between the output clock signals.

In the luminous module according to the invention, the DLL 140 is connected to each of the driver circuits 120 of the module so as to synchronize the commands of all of the driver circuits 120 of said module. Indeed, the DLL 140 is connected to the internal clock of each of the driver circuits 120 of the luminous module 110 and monitors these internal clocks so as to determine whether some of these internal clocks are lagging behind or running ahead of the others. If the DLL 140 detects that an internal clock is lagging behind or running ahead, then the DLL intervenes on the one or more internal clocks of the one or more driver circuits 120 that are running ahead so as to adjust these internal clocks that are running ahead to the internal clock of the driver circuit that is lagging furthest behind. In other words, the DLL 140 delays the internal clocks of the driver circuits 120 that are running ahead so that all of the driver circuits 120 are adjusted to the internal clock of the driver circuit 120 that is running furthest behind.

In the example of FIG. 3, the DLL 140 monitors the internal clock of a first driver circuit (clock signal line S1) and the internal clock of a second driver circuit (clock signal line S2), shown as a function of time t. This monitoring indicates that the clock signal S1 is running ahead of the clock signal S2: for example, the pulse i11 of the signal S1 is emitted before the pulse i21 of the signal S2. The DLL 140 then modifies the transmission phase of the clock signal S1 so that the pulses of the signal S1 are synchronous with those of the signal S2. In the example of FIG. 3, after the clock signals S1 and S2 have been adjusted, the pulse i14 of the signal S1 and the pulse i23 of the signal DS2 are transmitted simultaneously: the clock signals S1 and S2 are then synchronous.

The DLL 140 monitors all of the driver circuits 120 of the luminous module 110 in the same way as explained above and adjusts the clocks of all of these driver circuits so as to synchronize them. Thus, all of the driver circuits 120 of the luminous module 110 simultaneously control the LEDs 130 to which they are connected. Since the LEDs 130 are all close to a driver circuit, the emission of the various light rays by these LEDs is simultaneous.

However, if the organization into sectors requires certain LEDs 130 to be at a distance from the driver circuit 120 that is substantially different from the other LEDs of the same sector, for example the sector 151, the time lag potentially resulting from this difference in distance may be prevented by connecting all of the LEDs 130 of the sector 151 to the driver circuit 120 of this sector 151 by way of conductor tracks of identical length. Indeed, as is known in the field of luminous devices for motor vehicles, the LEDs 130 and the driver circuits 120 are mounted on a PCB (printed circuit board) or IMS (insulated metal substrate)-type substrate, where the LEDs 130 are each connected to the driver circuits 120 by a conductor track. The conductor tracks connecting each of the LEDs 130 of a sector to the driver circuit 120 of this sector have equal lengths.

For example, in the embodiment of FIG. 4, if the three LEDs 130 of the sector 151 are positioned, with respect to the driver circuit 120 of said sector 151, at non-equal physical distances, they may all be connected to the driver circuit 120 by way of conductor tracks (not shown) of equal lengths. All of the conductor tracks connecting the LEDs of one and the same sector to the driver circuit of the sector may have one and the same length. The length of these conductor tracks is determined as a function of the LED furthest from the driver circuit. All of the conductor tracks thus have a length equal to the length of the conductor track for connecting the driver circuit 120 to the LED furthest from said driver circuit. The conductor track connecting the furthest LED 130 to the driver circuit 120 is a conventional conductor track; the conductor tracks connecting the driver circuit 120 to the LEDs closest to the driver circuit 120 form delay lines. All of the LEDs 130 of one and the same sector 151, 152, 153 of the luminous module may thus be connected equidistantly from the driver circuit that controls them.

The distance between the driver circuit and an LED is a physical distance, that is to say a “point-to-point” length determined between the control output of the driver circuit and the input terminal of the LED. The concept of “furthest (away)” should therefore be understood in terms of physical distance, the LED furthest from the driver circuit being the LED whose distance from the driver circuit is greatest compared to the distances of the other LEDs from the driver circuit. Similarly, the concept of “closest” should be understood in terms of physical distance, the LED closest to the driver circuit being the LED whose distance from the driver circuit is shortest compared to the distances of the other LEDs from the driver circuit.

The physical distance between a driver circuit 120 and the LEDs 130 that it controls may thus vary, while the connection distance between this driver circuit 120 and these LEDs 130 is equal.

In other words, since all of the conductor tracks are of the same length, the conductor tracks of the LEDs closest to the driver circuit comprise loops and/or detours that make it possible to generate the delay lines. Thus, when the driver circuit 120 transmits a light ray emission command, the control signal transmitted by the driver circuit 120 is received simultaneously by all of the LEDs 130 connected to this driver circuit. The LEDs 130 of one and the same sector 151, 152, 153 therefore emit their light ray at the same time, in synchronized fashion. In parallel, the driver circuits 120 of the various sectors 151, 152, 153 are also synchronized by way of the DLL 140. There is thus a first synchronization level at the level of each sector 151, 152, 153, and a second synchronization level at the level of the luminous module. The light beam emitted by all of the LEDs 130 of the luminous module 110 is therefore necessarily synchronous, thereby allowing efficient modulation of the light beam, with all of the light rays of the LEDs of the module simultaneously emitting the same bit of the luminous code.

The luminous module 110 as has just been described makes it possible to emit a modulated light beam synchronously. To enable object detection, this luminous module is associated with a reception device for receiving the light beam reflected by the object (not visible in the figures). This reception device is integrated into the luminous device 100 of the invention. It makes it possible to receive light beams after they have been reflected by the object that it is sought to detect. This reception device comprises a light sensor or a set of light sensors; these one or more sensors may for example be photon counters, preferably avalanche diodes. The photon counters are preferably distributed over one and the same high-density substrate, preferably so as to constitute a detection matrix. The sensor is preferably associated with a blue-light optical filter, that is to say a bandpass filter designed to capture only light with a blue wavelength and suppress all other wavelengths. Indeed, white LEDs suitable for signaling comprise a light-emitting chip that emits blue light and to which there is applied a phosphor suitable for transforming a portion of the blue light into yellow light, the mixture of untransformed blue light emitted by the chip and yellow light transformed by the phosphor resulting in white light. Similarly, amber LEDs suitable for signaling comprise a chip that emits blue light and to which a suitable phosphor is applied. The blue-light optical filter makes it possible to separate the blue light, corresponding to the majority of the light beam, in particular corresponding to the emission line of the light-emitting chip, sent by the luminous module 110 and reflected by the object 20, from the rest of the spectrum of light coming from the sun or from any other external light sources emitting light in the visible range in the environment of the vehicle. The signal-to-noise ratio of the detection is thereby greatly improved.

This reception device is connected to a computing unit, which is installed in the luminous device or housed in any other location of the vehicle, preferably installed directly on the sensor, which determines the time of flight of the light beam and deduces therefrom a measurement of the distance between the vehicle and the detected object. The time of flight is the propagation time of the waves of the light beam emitted by the luminous module 110 in the environment, that is to say the time needed for the light beam to propagate to the object and return to the reception device. The distance between the object and the vehicle is determined from this time of flight. It should then be understood that the fact that the light beam is emitted by the luminous module 110 synchronously makes it possible to improve the determination of the time of flight. It should also be understood that the “object detection” function may be implemented by the luminous device 100 in parallel with its standard lighting function.

The luminous device 100 as has just been described may be used alone for object detection, in particular if the luminous device is a lighting device inside the vehicle.

The luminous device 100 may also be used in combination with another similar luminous device. The two luminous devices 100, for example the two front lighting devices of the vehicle, may be combined with one another for the purpose of detecting one and the same object.

The luminous device 100 may also be integrated into a driving assistance system for a motor vehicle. Indeed, driving assistance systems generally require a combination of two or even three distinct object detection devices, that is to say operating using different technologies. These object detection devices should be complementary. The luminous device according to the invention may constitute one of these object detection devices. It has the advantage of using a specific technology that has not yet been used, since it carries out object detection by way of a light beam in the visible range. It has the additional advantage of not adding to mass and crowding, since it uses a lighting device that is already present on the vehicle. Moreover, it has the advantage of being able to be implemented on multiple lighting devices of the same vehicle (for the purpose of detecting objects in one and the same zone of the vehicle or in different zones), without the risk of interference, simply by choosing a different luminous code for each of the luminous devices used.

Although it has been described by way of a certain number of examples, variants and embodiments, the luminous device according to the invention comprises various variants, modifications and improvements that will be obvious to those skilled in the art, it being understood that these variants, modifications and improvements form part of the scope of the invention. For example, on reading the present application, those skilled in the art will understand that it is easy to apply the principles thereof to other luminous devices from outside the motor vehicle, for example rear signaling lights of the motor vehicle.

What is claimed is:

1. A luminous device for a motor vehicle, comprising:
at least one luminous module configured to emit pulsed visible light modulated so as to transmit a high-frequency luminous code, the at least one first luminous module comprising includes at least two sectors each grouping together multiple light-emitting diodes and a driver circuit, each of the light-emitting diodes being supplied with electric power by the driver circuit of the respective sector, so as to modulate, in accordance with the high-frequency code, an electric power received by the light-emitting diodes of the respective sector in order to emit the pulsed visible light, and
a reception device for receiving the light emitted by the at least one first luminous module, for receiving the pulsed light, modulated in accordance with the code, after reflection of the pulsed light emitted by the at least one first luminous module from an object outside the vehicle,
wherein the modulation frequency is greater than 10 MHz, and
wherein the at least one first luminous module includes a delay-locked loop connected to the driver circuit of each of the sectors of the respective luminous module in order to synchronize the modulation, in accordance with the code, carried out by the driver circuits.

2. The luminous device as claimed in claim 1, wherein the delay-locked loop is connected to an internal clock of each of the driver circuits so as to adjust the clock of a driver circuit that is running ahead to the clock of a driver circuit that is lagging behind.

3. The luminous device as claimed in claim 1, wherein, in each sector, the light-emitting diodes are connected to the driver circuit by conductor tracks, all of the conductor tracks of one and the same sector having one and the same track length, such that all of the light-emitting diodes of one and the same sector, are controlled synchronously by the driver circuit.

4. The luminous device as claimed in claim 3, wherein, in each sector, the length of the conductor tracks is equal to the distance between the driver circuit and the light-emitting diode furthest from the driver circuit, the conductor tracks of the light-emitting diodes least far away from the driver circuit forming delay lines.

5. The luminous device as claimed in claim 1, wherein, for each sector of the at least one first luminous module, the light-emitting diodes of the sectors are grouped together on one and the same substrate.

6. The luminous device as claimed in any one of the preceding claim 1, further comprising at least one second luminous module connected to the delay-locked loop of the at least one first luminous module.

7. The luminous device as claimed claim 1, wherein the reception device includes at least one light sensor and one blue-light optical filter.

8. The luminous device as claimed claim 1, wherein the reception device is connected to a computing unit that determines a time of flight of waves of modulated pulsed light and measures a distance between the object and the luminous device

9. A driving assistance system for a motor vehicle, comprisescomprising at least one first device for detecting an object located in the environment of the motor vehicle, and a luminous device constituting a second object detection device that provides redundancy for the first object detection device, wherein the luminous device includes at least one luminous module configured to emit pulsed visible light modulated so as to transmit a high-frequency luminous code, the at least one first luminous module includes at least two sectors each grouping together multiple light-emitting diodes and a driver circuit, each of the light-emitting diodes being supplied with electric power by the driver circuit of the respective sector, so as to modulate, in accordance with the high-frequency code, an electric power received by the light-emitting diodes of the respective sector in order to emit the pulsed visible light, and a reception device for receiving the light emitted by the at least one first luminous module, for receiving the pulsed light, modulated in accordance with the code, after reflection of the pulsed light emitted by the at least one first luminous module from an object outside the vehicle, wherein the modulation frequency is greater than 10 MHz, and wherein the at least one first luminous module includes a delay-locked loop connected to the driver circuit of each of the sectors of the respective luminous module in order to synchronize the modulation, in accordance with the code, carried out by the driver circuits.
